(19) United States
(12) Patent Application Publication
(10) Pub. No.: US 2024/0006635 A1
(43) Pub. Date: Jan. 4, 2024

(54) MITIGATING INTER-STACK SHUNT CURRENT IN A FLOW BATTERY

(71) Applicant: Lockheed Martin Energy, LLC, Bethesda, MD (US)

(72) Inventors: Andrew Joseph Melough, Boston, MA (US); Kean Duffey, Arlington, VA (US); Adam Morris-Cohen, Andover, MA (US); Paolo Piagi, Andover, MA (US)

(21) Appl. No.: 18/343,547

(22) Filed: Jun. 28, 2023

Related U.S. Application Data
(60) Provisional application No. 63/356,672, filed on Jun. 29, 2022.

(51) Int. Cl. H01M 8/04276; H01M 8/04082

(52) U.S. Cl. CPC H01M 8/04276; H01M 8/04201

(57) ABSTRACT

Provided are flow batteries, comprising: a first reservoir containing a first electrolyte solution and one or more battery packs. A battery pack comprises a battery stack, an enclosure enclosing the battery stack, a first supply flow path, and a first return flow path. The first supply flow path comprises a substantially U-shaped bend such that a first portion of the first supply flow path and a second portion of the first supply flow path are positioned substantially parallel to each other and within the enclosure. The first return flow path comprises a substantially U-shaped bend such that a first portion of the first return flow path and a second portion of the first return flow path are positioned substantially parallel to each other and within the enclosure. These flow batteries are useful to mitigate inter-stack shunt currents.

### CROSS REFERENCE TO RELATED APPLICATION

This application claims benefit of U.S. Provisional Application No. 63/356,672 filed Jun. 29, 2022, the contents of which are incorporated by reference herein.

### TECHNICAL FIELD

The present disclosure relates to the field of flow batteries.

### BACKGROUND

Existing flow battery systems can include multiple stacks (e.g., stacks of electrochemical cells) electrically connected in series. The potential difference between the stacks can, however, lead to shunt currents that cause inefficiencies in the flow battery system.

Maximizing the length of fluidic piping in a flow battery system may mitigate shunt currents. External fluidic piping (e.g., piping external to the stacks) may be utilized to sufficiently maximize the length of fluidic piping. Such external fluidic piping, however, is space intensive, limits the geometry of the system, and requires a labor-intensive manufacturing process.

Another source of inefficiency for existing flow batteries is fluidic pressure drops. Such fluidic pressure drops may occur when the system is running at high powers. Minimizing the length of the fluidic piping in a flow battery system may mitigate fluidic pressure drops. Thus, it is especially challenging to mitigate shunt currents (e.g., by maximizing the length of fluidic piping) while simultaneously mitigating fluidic pressure drops.

Accordingly, there is a long-felt need in the art for approaches of mitigating inter-stack shunt currents in flow batteries.

### SUMMARY

In meeting the described long-felt need, the present disclosure provides, inter alia, a flow battery that includes fluidic piping forming substantially U-shaped bends, such that a first portion of the fluidic piping and a second portion of the fluidic piping are positioned substantially parallel to each other and within the enclosure. In this manner, a length of the fluidic piping can be sufficiently extended to mitigate inter-stack shunt currents, while still avoiding the downsides of external fluidic piping.

The present disclosure also provides, inter alia, a flow battery that includes a controller configured to alternate flow of electrolyte solution between shorter and longer fluidic piping paths depending on an operating power of the flow battery. If the flow battery is operating at a high power, the controller can direct flow of electrolyte solution through a shorter fluidic piping path—thus mitigating fluidic pressure drops that can occur when the system is running at high powers. If the flow battery is operating at a low power, the controller can direct flow of electrolyte solution through a longer fluidic piping path—thus mitigating shunt currents that can occur when the system is running at low powers.

In meeting the described challenges, the present disclosure first provides a flow battery comprising: a first reservoir containing a first electrolyte solution; and one or more battery packs, a battery pack comprising: a battery stack comprising at least one electrochemical cell; an enclosure enclosing the battery stack; a first supply flow path configured to supply the first electrolyte solution to the battery stack, the first supply flow path being in fluid communication with the first reservoir and the battery stack, the first supply flow path comprising a substantially U-shaped bend such that a first portion of the first supply flow path and a second portion of the first supply flow path are positioned substantially parallel to each other and within the enclosure; and a first return flow path configured to return the first electrolyte solution to the first reservoir after the first electrolyte solution has passed through the battery stack, wherein the first return flow path is in fluid communication with the battery stack and the first reservoir, the first return flow path forming a substantially U-shaped bend such that a first portion of the first return flow path and a second portion of the first return flow path are positioned substantially parallel to each other and within the enclosure.

Further disclosed is a flow battery comprising: a first reservoir containing a first electrolyte solution; at least one battery stack; a first supply flow path having a first length, the first supply flow path configured to supply the first electrolyte solution to the at least one battery stack, wherein the first supply flow path is in fluid communication with the first reservoir and the at least one battery stack; a second supply flow path having a second length greater than the first length, the second supply flow path configured to supply the first electrolyte solution to the at least one battery stack, wherein the second supply flow path is in fluid communication with the first reservoir and the at least one battery stack; and a first controller configured to direct flow of the first electrolyte solution from the first reservoir to the at least one battery stack between the first supply flow path and the second supply flow path based at least on a state of charge of the first electrolyte solution flowing from the first reservoir to the at least one battery stack.

Also provided are methods, comprising operating a flow battery according to the present disclosure (e.g., according to any one of Aspects 1-20), collecting a current from a flow battery according to the present disclosure (e.g., according to any one of Aspects 1-20), and providing a current to a flow battery according to the present disclosure (e.g., according to any one of Aspects 1-20).

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 provides a front view of a flow battery assembly according to the present disclosure.

FIG. 2 provides an alternative view of the flow battery assembly of FIG. 1.

FIG. 3 provides a side view of a battery pack useable in the flow battery assembly shown in FIG. 1 and FIG. 2.

FIG. 4 provides a front view of a flow battery assembly according to the present disclosure.

FIG. 5 provides an alternative front view of the flow battery assembly shown in FIG. 4.

FIG. 6 provides a front view of a flow battery assembly according to the present disclosure.

FIG. 7 provides a cross-sectional view of a battery pack 700 according to the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

### FIGURES

The appended figures are illustrative only and do not limit the scope of the present disclosure or the appended claims.

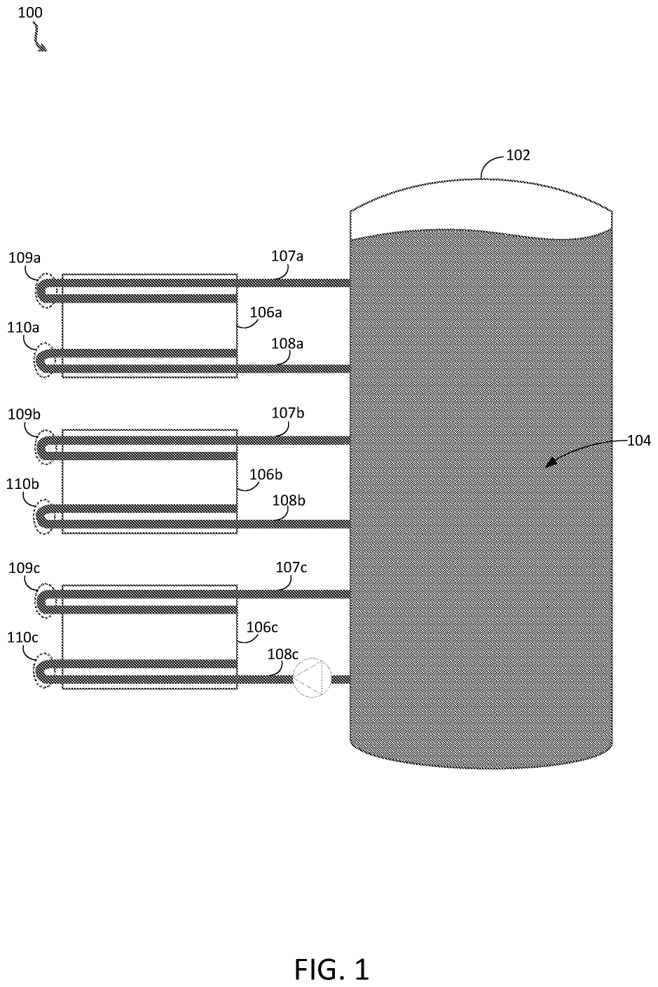

FIG. 1 provides a front view of a flow battery assembly 100 according to the present disclosure. As shown, assembly 100 can include a first reservoir 102 and one or more battery packs 106a-c. First reservoir 102 can contain a first electrolyte solution 104. First electrolyte solution 104 can be either a liquid anolyte or a liquid catholyte. The one or more battery packs 106a-c can be electrically connected to each other in series. Each battery pack 106a-c can include a battery stack comprising at least one electrochemical cell and an enclosure enclosing the battery stack. A battery stack can include any number of electrochemical cells and can vary depending on the needs of the user. In the example shown in FIG. 1, assembly 100 includes three battery packs. This is exemplary only, and the number of battery packs is not fixed and can vary depending on the needs of the user. As an example, an assembly can include one, two, three, four, five, six, or more (i.e., a plurality of) battery packs.

Each battery pack 106a-c can include a first supply flow path 108a-c. Each first supply flow path 108a-c can be in fluid communication with first reservoir 102 and the corresponding battery stack. In the example shown in FIG. 1, battery pack 106a includes first supply flow path 108a, battery pack 106b includes first supply flow path 108b, and battery pack 106c includes first supply flow path 108c. Each first supply flow path 108a-c can be configured to supply first electrolyte solution 104 to the corresponding battery stack. For example, first supply flow path 108a can be configured to supply first electrolyte solution 104 to battery pack 106a, first supply flow path 108b can be configured to supply first electrolyte solution 104 to battery pack 106b, and first supply flow path 108c can be configured to supply first electrolyte solution 104 to battery pack 106c.

Each first supply flow path 108a-c can comprise a substantially U-shaped bend 110a-c such that a first portion of the first supply flow path 108a-c and a second portion of the first supply flow path 108a-c are positioned substantially parallel to each other and within the enclosure. For example, first supply flow path 108a can comprise a substantially U-shaped bend 110a such that a first portion of the first supply flow path 108a and a second portion of the first supply flow path 108a are positioned substantially parallel to each other and within the enclosure. First supply flow path 108b can comprise a substantially U-shaped bend 110b such that a first portion of the first supply flow path 108b and a second portion of the first supply flow path 108b are positioned substantially parallel to each other and within the enclosure. First supply flow path 108c can comprise a substantially U-shaped bend 110c such that a first portion of the first supply flow path 108c and a second portion of the first supply flow path 108c are positioned substantially parallel to each other and within the enclosure. In this manner, a length of each first supply flow path 108a-c can be sufficiently extended to mitigate inter-stack shunt currents, while avoiding the downsides of external fluidic piping.

In the example shown in FIG. 1, each first supply flow path 108a-c comprises one substantially U-shaped bend such that a first portion of the first supply flow path 108a-c and a second portion of the first supply flow path 108a-c are positioned substantially parallel to each other and within the enclosure. This is exemplary only, and the number of substantially U-shaped bends is not fixed and can vary depending on the needs of the user. For example, any of the first supply flow paths 108a-c can further form an additional substantially U-shaped bend such that a third portion of the first supply flow path 108a-c and a fourth portion of the first supply flow path 108a-c are positioned substantially parallel to each other. The third portion and the fourth portion can be positioned substantially parallel to the first portion of the first supply flow path 108a-c and the second portion of the first supply flow path 108a-c and can be positioned within the enclosure.

In the example shown in FIG. 1, substantially U-shaped bends 110a-c are positioned external to the enclosure. This is exemplary only, and the positioning of the substantially U-shaped bends is not fixed and can vary depending on the needs of the user. For example, one or more substantially U-shaped bends can be positioned internal to the enclosure.

Each battery pack 106a-c can include a first return flow path 107a-c. Each first return flow path 107a-c can be in fluid communication with first reservoir 102 and the corresponding battery stack. In the example shown in FIG. 1, battery pack 106a includes first return flow path 107a, battery pack 106b includes first return flow path 107b, and battery pack 106c includes first return flow path 107c. Each first return flow path 107a-c can be configured to return first electrolyte solution 104 to first reservoir 102 after first electrolyte solution 104 has passed through the corresponding battery stack. For example, first return flow path 107a can be configured to return first electrolyte solution 104 to first reservoir 102 after first electrolyte solution 104 has passed through the battery stack corresponding to battery pack 106a, first return flow path 107b can be configured to return first electrolyte solution 104 to first reservoir 102 after first electrolyte solution 104 has passed through the battery stack corresponding to battery pack 106b, and first return flow path 107c can be configured to return first electrolyte solution 104 to first reservoir 102 after first electrolyte solution 104 has passed through the battery stack corresponding to battery pack 106c.

Each first return flow path 107a-c can comprise a substantially U-shaped bend 109a-c such that a first portion of the first return flow path 107a-c and a second portion of the first return flow path 107a-c are positioned substantially parallel to each other and within the enclosure. For example, first return flow path 107a can comprise a substantially U-shaped bend 109a such that a first portion of the first return flow path 107a and a second portion of the first return flow path 107a are positioned substantially parallel to each other and within the enclosure. First return flow path 107b can comprise a substantially U-shaped bend 109b such that a first portion of the first return flow path 107b and a second portion of the first return flow path 107b are positioned substantially parallel to each other and within the enclosure. First return flow path 107c can comprise a substantially U-shaped bend 109c such that a first portion of the first return flow path 107c and a second portion of the first return flow path 107c are positioned substantially parallel to each other and within the enclosure.

In the example shown in FIG. 1, each first return flow path 107a-c comprises one substantially U-shaped bend such that a first portion of the first return flow path 107a-c and a second portion of the first return flow path 107a-c are positioned substantially parallel to each other and within the enclosure. This is exemplary only, and the number of substantially U-shaped bends is not fixed and can vary depending on the needs of the user. For example, any of the first return flow paths 107a-c can further form an additional substantially U-shaped bend such that a third portion of the first return flow path 107a-c and a fourth portion of the first return flow path 107a-c are positioned substantially parallel to each other. The third portion and the fourth portion can be positioned substantially parallel to the first portion of the first return flow path 107a-c and the second portion of the first return flow path 107a-c and can be positioned within the enclosure. In this manner, a length of each first return flow path 107a-c can be sufficiently extended to mitigate inter-stack shunt currents, while avoiding the downsides of external fluidic piping. In a given system that includes multiple substantially U-shaped bends, the U-shaped bends can all lie in a single plane. This is not a requirement, however, as U-shaped bends can lie in different planes from one another. Such different planes can be parallel to one another, but can also be angled relative to one another. As an example, a first substantially U-shaped bend of a battery pack can lie in a plane that is vertical (i.e., the supply flow path and the return flow path of that first substantially U-shaped bend lie in a plane that is vertical), and a second U-shaped bend of the battery pack can lie in a plane that is inclined 45° from the vertical (i.e., the supply flow path and the return flow path of that first substantially U-shaped bend lie in a plane that is inclined from vertical).

In the example shown in FIG. 1, substantially U-shaped bends 109a-c are positioned external to the enclosure. This is exemplary only, and the positioning of the substantially U-shaped bends is not fixed and can vary depending on the needs of the user. For example, one or more substantially U-shaped bends can be positioned internal to the enclosure.

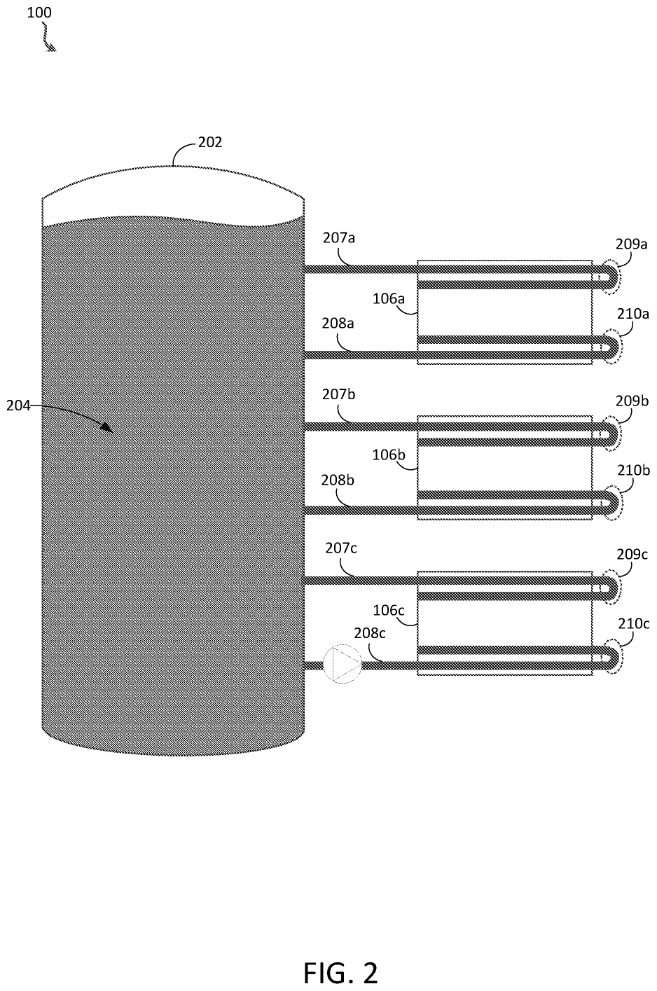

FIG. 2 provides another front view of flow battery assembly 100 shown in FIG. 1. As shown, assembly 100 can include a second reservoir 202. Second reservoir 202 can contain a second electrolyte solution 204. Second electrolyte solution 204 can be either a liquid anolyte or a liquid catholyte. For example, if first electrolyte solution 104 is a liquid anolyte, second electrolyte solution 204 can be a liquid catholyte, or vice versa.

Each battery pack 106a-c can include a second supply flow path 208a-c. Each second supply flow path 208a-c can be in fluid communication with second reservoir 202 and the corresponding battery stack. In the example shown in FIG. 2, battery pack 106a includes second supply flow path 208a, battery pack 106b includes second supply flow path 208b, and battery pack 106c includes second supply flow path 208c. Each second supply flow path 208a-c can be configured to supply second electrolyte solution 204 to the corresponding battery stack. For example, second supply flow path 208a can be configured to supply second electrolyte solution 204 to battery pack 106a, second supply flow path 208b can be configured to supply second electrolyte solution 204 to battery pack 106b, and second supply flow path 208c can be configured to supply second electrolyte solution 204 to battery pack 106c.

Each second supply flow path 208a-c can comprise a substantially U-shaped bend 210a-c such that a first portion of the second supply flow path 208a-c and a second portion of the second supply flow path 208a-c are positioned substantially parallel to each other and within the enclosure. For example, second supply flow path 208a can comprise a substantially U-shaped bend 210a such that a first portion of the second supply flow path 208a and a second portion of the second supply flow path 208a are positioned substantially parallel to each other and within the enclosure. Second supply flow path 208b can comprise a substantially U-shaped bend 210b such that a first portion of the second supply flow path 208b and a second portion of the second supply flow path 208b are positioned substantially parallel to each other and within the enclosure. Second supply flow path 208c can comprise a substantially U-shaped bend 210c such that a first portion of the second supply flow path 208c and a second portion of the second supply flow path 208c are positioned substantially parallel to each other and within the enclosure. In this manner, a length of each second supply flow path 208a-c can be sufficiently extended to mitigate inter-stack shunt currents, while avoiding the downsides of external fluidic piping.

In the example shown in FIG. 2, each second supply flow path 208a-c comprises one substantially U-shaped bend such that a first portion of the second supply flow path 208a-c and a second portion of the second supply flow path 208a-c are positioned substantially parallel to each other and within the enclosure. This is exemplary only, and the number of substantially U-shaped bends is not fixed and can vary depending on the needs of the user. For example, any of the second supply flow paths 208a-c can further form an additional substantially U-shaped bend such that a third portion of the second supply flow path 208a-c and a fourth portion of the second supply flow path 208a-c are positioned substantially parallel to each other. The third portion and the fourth portion can be positioned substantially parallel to the first portion of the second supply flow path 208a-c and the second portion of the second supply flow path 208a-c and can be positioned within the enclosure.

In the example shown in FIG. 2, substantially U-shaped bends 210a-c are positioned external to the enclosure. This is exemplary only, and the positioning of the substantially U-shaped bends is not fixed and can vary depending on the needs of the user. For example, one or more substantially U-shaped bends can be positioned internal to the enclosure.

Each battery pack 106a-c can include a second return flow path 207a-c. Each second return flow path 207a-c can be in fluid communication with second reservoir 202 and the corresponding battery stack. In the example shown in FIG. 2, battery pack 106a includes second return flow path 207a, battery pack 106b includes second return flow path 207b, and battery pack 106c includes second return flow path 207c. Each second return flow path 207a-c can be configured to return second electrolyte solution 204 to second reservoir 202 after second electrolyte solution 204 has passed through the corresponding battery stack. For example, second return flow path 207a can be configured to return second electrolyte solution 204 to second reservoir 202 after second electrolyte solution 204 has passed through the battery stack corresponding to battery pack 106a, second return flow path 207b can be configured to return second electrolyte solution 204 to second reservoir 202 after second electrolyte solution 204 has passed through the battery stack corresponding to battery pack 106b, and second return flow path 207c can be configured to return second electrolyte solution 204 to second reservoir 202 after second electrolyte solution 204 has passed through the battery stack corresponding to battery pack 106c.

Each second return flow path 207a-c can comprise a substantially U-shaped bend 209a-c such that a first portion of the second return flow path 207a-c and a second portion of the second return flow path 207a-c are positioned substantially parallel to each other and within the enclosure. For example, second return flow path 207a can comprise a substantially U-shaped bend 209a such that a first portion of the second return flow path 207a and a second portion of the second return flow path 207a are positioned substantially parallel to each other and within the enclosure. Second return flow path 207b can comprise a substantially U-shaped bend 209b such that a first portion of the second return flow path 207b and a second portion of the second return flow path 207b are positioned substantially parallel to each other and within the enclosure. Second return flow path 207c can comprise a substantially U-shaped bend 209c such that a first portion of the second return flow path 207c and a second portion of the second return flow path 207c are positioned substantially parallel to each other and within the enclosure. In this manner, a length of each second return flow path 207a-c can be sufficiently extended to mitigate inter-stack shunt currents, while avoiding the downsides of external fluidic piping.

In the example shown in FIG. 2, each second return flow path 207a-c comprises one substantially U-shaped bend such that a first portion of the second return flow path 207a-c and a second portion of the second return flow path 207a-c are positioned substantially parallel to each other and within the enclosure. This is exemplary only, and the number of substantially U-shaped bends is not fixed and can vary depending on the needs of the user. For example, any of the second return flow paths 207a-c can further form an additional substantially U-shaped bend such that a third portion of the second return flow path 207a-c and a fourth portion of the second return flow path 207a-c are positioned substantially parallel to each other. The third portion and the fourth portion can be positioned substantially parallel to the first portion of the second return flow path 207a-c and the second portion of the second return flow path 207a-c and can be positioned within the enclosure.

In the example shown in FIG. 2, substantially U-shaped bends 209a-c are positioned external to the enclosure. This is exemplary only, and the positioning of the substantially U-shaped bends is not fixed and can vary depending on the needs of the user. For example, one or more substantially U-shaped bends can be positioned internal to the enclosure.

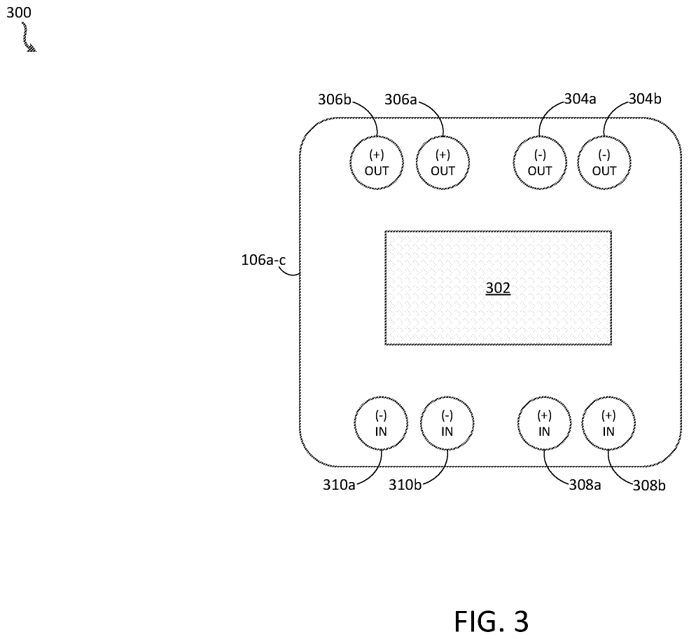

FIG. 3 provides a side view 300 of battery pack 106a-c shown in FIG. 1 and FIG. 2. Each battery pack 106a-c can include openings 308a-b. Openings 308a-b can be configured to receive first supply flow paths 108a-c. For example, first supply flow path 108a can exit an enclosure of battery pack 106a through opening 308a. The first supply flow path 108a can form substantially U-shaped bend 110a outside of the enclosure and re-enter the enclosure through opening 308b. First supply flow paths 108b-c can exit and re-enter openings 308a-b in battery packs 106b-c in a similar manner.

Each battery pack 106a-c can include openings 306a-b. Openings 306a-b can be configured to receive first return flow paths 107a-c. For example, first return flow path 107a can exit an enclosure of battery pack 106a through opening 306a. The first return flow path 107a can form substantially U-shaped bend 109a outside of the enclosure and re-enter the enclosure through opening 306b. First return flow paths 107b-c can exit and re-enter openings 307a-b in battery packs 106b-c in a similar manner.

Each battery pack 106a-c can include openings 310a-b. Openings 310a-b can be configured to receive second supply flow paths 208a-c. For example, second supply flow path 208a can exit an enclosure of battery pack 106a through opening 310a. The second supply flow path 208a can form substantially U-shaped bend 210a outside of the enclosure and re-enter the enclosure through opening 310b. Second supply flow paths 208b-c can exit and re-enter openings 310a-b in battery packs 106b-c in a similar manner.

Each battery pack 106a-c can include openings 304a-b. Openings 304a-b can be configured to receive second return flow paths 207a-c. For example, second return flow path 207a can exit an enclosure of battery pack 106a through opening 304a. The second return flow path 207a can form substantially U-shaped bend 209a outside of the enclosure and re-enter the enclosure through opening 304b. Second return flow paths 207b-c can exit and re-enter openings 304a-b in battery packs 106b-c in a similar manner.

Openings 304a-b, 306a-b, 308a-b, and 310a-b can be holes, slits, apertures, or any other opening that is configured to receive return or supply flow paths. As described above, the number of substantially U-shaped bends is not fixed and can vary depending on the needs of the user. Additional openings can be included in battery pack 106a-c if additional substantially U-shaped bends are utilized.

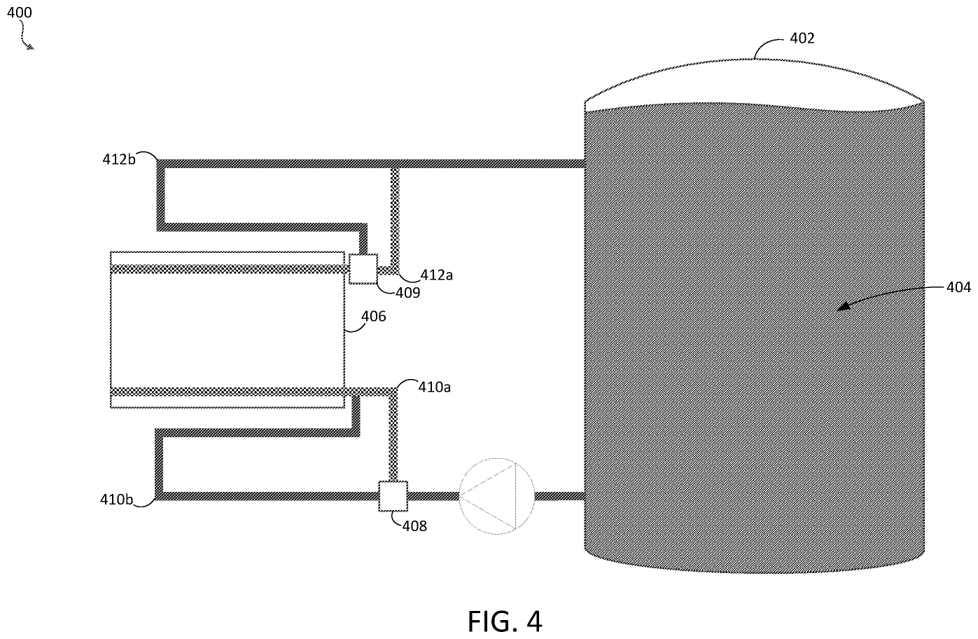

FIG. 4 provides a front view of a flow battery assembly 400 according to the present disclosure. As shown, assembly 400 can include a first reservoir 402 and at least one battery pack 406. First reservoir 402 can contain a first electrolyte solution 404. First electrolyte solution 404 can be either a liquid anolyte or a liquid catholyte. Each battery pack 406 can include a battery stack comprising at least one electrochemical cell and an enclosure enclosing the battery stack. A battery stack can include any number of electrochemical cells and can vary depending on the needs of the user. In the example shown in FIG. 4, assembly 400 includes one battery pack. This is exemplary only, and the number of battery packs is not fixed and can vary depending on the needs of the user. As an example, an assembly can include two, three, four, five, six, or more battery packs.

Each battery pack 406 can include a first supply flow path 410a. First supply flow path 410a can have a first length. First supply flow path 410a can be in fluid communication with first reservoir 402 and the battery stack of battery pack 406. First supply flow path 410a can be configured to supply first electrolyte solution 404 to the battery stack of battery pack 406. Each battery pack 406 can include a second supply flow path 410b. Second supply flow path 410b can have a second length. The second length can be greater than the first length. Second supply flow path 410b can be in fluid communication with first reservoir 402 and the battery stack of battery pack 406. Second supply flow path 410b can be configured to supply first electrolyte solution 404 to the battery stack of battery pack 406. Second supply flow path 410b can include at least a portion of first supply flow path 410a.

Each battery pack 406 can include a first supply controller 408. First supply controller 408 can be configured to direct flow of first electrolyte solution 404 from first reservoir 402 to the battery stack of battery pack 406 between first supply flow path 410a and second supply flow path 410b based on certain conditions.

First supply controller 408 can be configured to direct flow of first electrolyte solution 404 from first reservoir 402 to the battery stack of battery pack 406 based at least on an operating power of assembly 400. If assembly 400 is operating at a high power (e.g., high nominal power), fluidic pressure drops can be a prominent source of inefficiency for assembly 400. Accordingly, if an operating power of assembly 400 meets or exceeds a power threshold, first supply controller 408 can be configured to direct flow of first electrolyte solution 404 from first reservoir 402 to the battery stack of battery pack 406 via the shorter of the two supply flow paths—first supply flow path 410a. Directing the flow of first electrolyte solution 404 from first reservoir 402 to the battery stack of battery pack 406 via the shorter of the two supply flow paths can mitigate fluidic pressure drops.

Conversely, if assembly 400 is operating at a low power (e.g., low nominal power), shunt currents, rather than fluidic pressure drops, can be a prominent source of inefficiency for assembly 400. Accordingly, if an operating power of assembly 400 is less than the power threshold, first supply controller 408 can be configured to direct flow of first electrolyte solution 404 from first reservoir 402 to the battery stack of battery pack 406 via the longer of the two supply flow paths—second supply flow path 410b. Directing the flow of first electrolyte solution 404 from first reservoir 402 to the battery stack of battery pack 406 via the longer of the two supply flow paths can mitigate shunt currents.

Additionally, or alternatively, first supply controller 408 can be configured to direct flow of first electrolyte solution 404 from first reservoir 402 to the battery stack of battery pack 406 based at least on a state of charge (SOC) of first electrolyte solution 404 flowing from first reservoir 402 to the battery stack. Shunt currents can be higher at higher SOCs. Accordingly, if a SOC of first electrolyte solution 404 meets or exceeds a SOC threshold (e.g., 80% SOC), first supply controller 408 can be configured to direct flow of first electrolyte solution 404 from first reservoir 402 to the battery stack of battery pack 406 via the longer of the two supply flow paths—second supply flow path 410b. Directing the flow of first electrolyte solution 404 from first reservoir 402 to the battery stack of battery pack 406 via the longer of the two supply flow paths can mitigate shunt currents.

If a SOC of first electrolyte solution 404 is high (e.g., meets or exceeds a SOC threshold) and assembly 400 is operating at a low power (e.g., at a power less than the power threshold), shunt currents can have the most detrimental impact on the efficiency of assembly 400. Thus, the benefit of directing the flow of first electrolyte solution 404 from first reservoir 402 to the battery stack of battery pack 406 via the longer of the two supply flow paths can be useful in such a scenario.

Each battery pack 406 can include a first return flow path 412a. First return flow path 412 can have a third length. First return flow path 412a can be in fluid communication with first reservoir 402 and the battery stack of battery pack 406. First return flow path 412a can be configured to return first electrolyte solution 404 to first reservoir 402 after first electrolyte solution 404 has passed through the battery stack. Each battery pack 406 can include a second return flow path 412b. Second return flow path 412b can have a fourth length. The fourth length can be greater than the third length. Second return flow path 412b can be in fluid communication with first reservoir 402 and the battery stack of battery pack 406. Second return flow path 412b can be configured to return first electrolyte solution 404 to first reservoir 402 after first electrolyte solution 404 has passed through the battery stack. Second return flow path 412b can include at least a portion of first return flow path 412a.

Each battery pack 406 can include a first return controller 409. First return controller 409 can be configured to direct flow of first electrolyte solution 404 from the battery stack to first reservoir 402 between first return flow path 412a and second return flow path 412b based on certain conditions.

First return controller 409 can be configured to direct flow of first electrolyte solution 404 from the battery stack of battery pack 406 to first reservoir 402 based at least on an operating power of assembly 400. If assembly 400 is operating at a high power (e.g., high nominal power), fluidic pressure drops can be a prominent source of inefficiency for assembly 400. Accordingly, if an operating power of assembly 400 meets or exceeds a power threshold, first return controller 409 can be configured to direct flow of first electrolyte solution 404 from the battery stack of battery pack 406 to first reservoir 402 via the shorter of the two return flow paths—first return flow path 412a. Directing the flow of first electrolyte solution 404 from the battery stack of battery pack 406 to first reservoir 402 via the shorter of the two return flow paths can mitigate fluidic pressure drops.

Conversely, if assembly 400 is operating at a low power (e.g., low nominal power), shunt currents, rather than fluidic pressure drops, can be a prominent source of inefficiency for assembly 400. Accordingly, if an operating power of assembly 400 is less than the power threshold, first return controller 409 can be configured to direct flow of first electrolyte solution 404 from the battery stack of battery pack 406 to first reservoir 402 via the longer of the two return flow paths—second return flow path 412b. Directing the flow of first electrolyte solution 404 from the battery stack of battery pack 406 to first reservoir 402 via the longer of the two return flow paths can mitigate shunt currents.

Additionally, or alternatively, first return controller 409 can be configured to direct flow of first electrolyte solution 404 from the battery stack of battery pack 406 to first reservoir 402 based at least on a state of charge (SOC) of first electrolyte solution 404 flowing from the battery stack to first reservoir 402. Shunt currents can be higher at higher SOCs. Accordingly, if a SOC of first electrolyte solution 404 meets or exceeds a SOC threshold (e.g., 80% SOC), first return controller 409 can be configured to direct flow of first electrolyte solution 404 from the battery stack of battery pack 406 to first reservoir 402 via the longer of the two return flow paths—second return flow path 412b. Directing the flow of first electrolyte solution 404 from the battery stack of battery pack 406 to first reservoir 402 via the longer of the two return flow paths can mitigate shunt currents.

If a SOC of first electrolyte solution 404 is high (e.g., meets or exceeds a SOC threshold) and assembly 400 is operating at a low power (e.g., at a power less than the power threshold), shunt currents can have the most detrimental impact on the efficiency of assembly 400. Thus, the benefit of directing the flow of first electrolyte solution 404 from the battery stack of battery pack 406 to first reservoir 402 to via the longer of the two return flow paths can be useful in such a scenario.

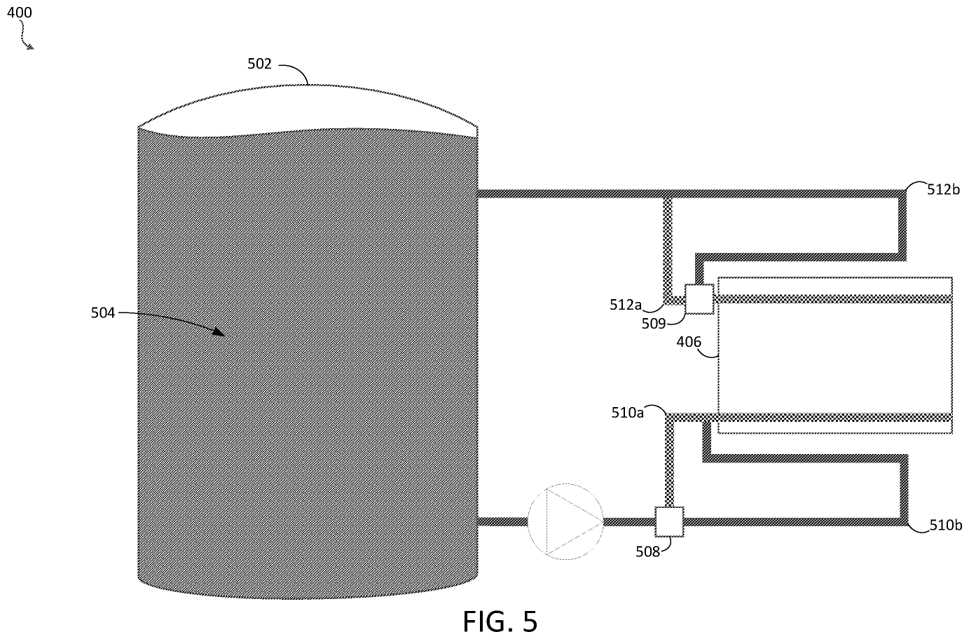

FIG. 5 provides another front view of flow battery assembly 400 shown in FIG. 4. As shown, assembly 400 can include a second reservoir 202. Second reservoir 502 can contain a second electrolyte solution 504. Second electrolyte solution 504 can be either a liquid anolyte or a liquid catholyte. For example, if first electrolyte solution 404 is a liquid anolyte, second electrolyte solution 504 can be a liquid catholyte, or vice versa.

Each battery pack 406 can include a third supply flow path 510a. Third supply flow path 510 can have a fifth length. Third supply flow path 510a can be in fluid communication with second reservoir 502 and the battery stack of battery pack 406. Third supply flow path 510a can be configured to supply second electrolyte solution 504 to the battery stack of battery pack 406. Each battery pack 406 can include a fourth supply flow path 510b. Fourth supply flow path 510b can have a sixth length. The sixth length can be greater than the fifth length. Fourth supply flow path 510b can be in fluid communication with second reservoir 502 and the battery stack of battery pack 406. Fourth supply flow path 510b can be configured to supply second electrolyte solution 504 to the battery stack of battery pack 406. Fourth supply flow path 510b can include at least a portion of third supply flow path 510a.

Each battery pack 406 can include a second supply controller 508. Second supply controller 508 can be configured to direct flow of second electrolyte solution 504 from second reservoir 502 to the battery stack of battery pack 406 between third supply flow path 510a and fourth supply flow path 510b based on certain conditions.

Second supply controller 508 can be configured to direct flow of second electrolyte solution 504 from second reservoir 502 to the battery stack of battery pack 406 based at least on an operating power of assembly 400. If assembly 400 is operating at a high power (e.g., high nominal power), fluidic pressure drops can be a prominent source of inefficiency for assembly 400. Accordingly, if an operating power of assembly 400 meets or exceeds a power threshold, second supply controller 508 can be configured to direct flow of second electrolyte solution 504 from second reservoir 502 to the battery stack of battery pack 406 via the shorter of the two supply flow paths—third supply flow path 510a. Directing the flow of second electrolyte solution 504 from second reservoir 502 to the battery stack of battery pack 406 via the shorter of the two supply flow paths can mitigate fluidic pressure drops.

Conversely, if assembly 400 is operating at a low power (e.g., low nominal power), shunt currents, rather than fluidic pressure drops, can be a prominent source of inefficiency for assembly 400. Accordingly, if an operating power of assembly 400 is less than the power threshold, second supply controller 508 can be configured to direct flow of second electrolyte solution 504 from second reservoir 502 to the battery stack of battery pack 406 via the longer of the two supply flow paths—fourth supply flow path 510b. Directing the flow of second electrolyte solution 504 from second reservoir 502 to the battery stack of battery pack 406 via the longer of the two supply flow paths can mitigate shunt currents.

Additionally, or alternatively, second supply controller 508 can be configured to direct flow of second electrolyte solution 504 from second reservoir 502 to the battery stack of battery pack 406 based at least on a state of charge (SOC) of second electrolyte solution 504 flowing from second reservoir 502 to the battery stack. Shunt currents can be higher at higher SOCs. Accordingly, if a SOC of second electrolyte solution 504 meets or exceeds a SOC threshold (e.g., 80% SOC), second supply controller 508 can be configured to direct flow of second electrolyte solution 504 from second reservoir 502 to the battery stack of battery pack 406 via the longer of the two supply flow paths—fourth supply flow path 510b. Directing the flow of second electrolyte solution 504 from second reservoir 502 to the battery stack of battery pack 406 via the longer of the two supply flow paths can mitigate shunt currents.

If a SOC of second electrolyte solution 504 is high (e.g., meets or exceeds a SOC threshold) and assembly 400 is operating at a low power (e.g., at a power less than the power threshold), shunt currents can have the most detrimental impact on the efficiency of assembly 400. Thus, the benefit of directing the flow of second electrolyte solution 504 from second reservoir 502 to the battery stack of battery pack 406 via the longer of the two supply flow paths can be useful in such a scenario.

Each battery pack 406 can include a third return flow path 512a. Third return flow path 512 can have a seventh length. Third return flow path 512a can be in fluid communication with second reservoir 502 and the battery stack of battery pack 406. Third return flow path 512a can be configured to return second electrolyte solution 504 from the battery stack to second reservoir 502 after second electrolyte solution 504 has passed through the at least one battery stack. Each battery pack 406 can include a fourth return flow path 512b. Fourth return flow path 512b can have an eighth length. The eighth length can be greater than the seventh length. Fourth return flow path 512b can be in fluid communication with second reservoir 502 and the battery stack of battery pack 406. Fourth return flow path 512b can be configured to return second electrolyte solution 504 from the battery stack to second reservoir 502 after second electrolyte solution 504 has passed through the at least one battery stack. Fourth return flow path 512b can include at least a portion of third return flow path 512a.

Each battery pack 406 can include a second return controller 509. Second return controller 509 can be configured to direct flow of second electrolyte solution 504 from the battery stack to second reservoir 502 between third return flow path 512a and fourth return flow path 512b based on certain conditions.

Second return controller 509 can be configured to direct flow of second electrolyte solution 504 from the battery stack of battery pack 406 to second reservoir 502 based at least on an operating power of assembly 400. If assembly 400 is operating at a high power (e.g., high nominal power), fluidic pressure drops can be a prominent source of inefficiency for assembly 400. Accordingly, if an operating power of assembly 400 meets or exceeds a power threshold, second return controller 509 can be configured to direct flow of second electrolyte solution 504 from the battery stack of battery pack 406 to second reservoir 502 via the shorter of the two return flow paths—third return flow path 512a. Directing the flow of second electrolyte solution 504 from the battery stack of battery pack 406 to second reservoir 502 via the shorter of the two return flow paths can mitigate fluidic pressure drops.

Conversely, if assembly 400 is operating at a low power (e.g., low nominal power), shunt currents, rather than fluidic pressure drops, can be a prominent source of inefficiency for assembly 400. Accordingly, if an operating power of assembly 400 is less than the power threshold, second return controller 509 can be configured to direct flow of second electrolyte solution 504 from the battery stack of battery pack 406 to second reservoir 502 via the longer of the two return flow paths—fourth return flow path 512b. Directing the flow of second electrolyte solution 504 from the battery stack of battery pack 406 to second reservoir 502 via the longer of the two return flow paths can mitigate shunt currents.

Additionally, or alternatively, second return controller 509 can be configured to direct flow of second electrolyte solution 504 from the battery stack of battery pack 406 to second reservoir 502 based at least on a state of charge (SOC) of second electrolyte solution 504 flowing from the battery stack to second reservoir 502. Shunt currents can be higher at higher SOCs. Accordingly, if a SOC of second electrolyte solution 504 meets or exceeds a SOC threshold (e.g., 80% SOC), second return controller 509 can be configured to direct flow of second electrolyte solution 504 from the battery stack of battery pack 406 to second reservoir 502 via the longer of the two return flow paths—fourth return flow path 512b. Directing the flow of second electrolyte solution 504 from the battery stack of battery pack 406 to second reservoir 502 via the longer of the two return flow paths can mitigate shunt currents.

If a SOC of second electrolyte solution 504 is high (e.g., meets or exceeds a SOC threshold) and assembly 400 is operating at a low power (e.g., at a power less than the power threshold), shunt currents can have the most detrimental impact on the efficiency of assembly 400. Thus, the benefit of directing the flow of second electrolyte solution 504 from the battery stack of battery pack 406 to first reservoir 402 to via the longer of the two return flow paths can be useful in such a scenario.

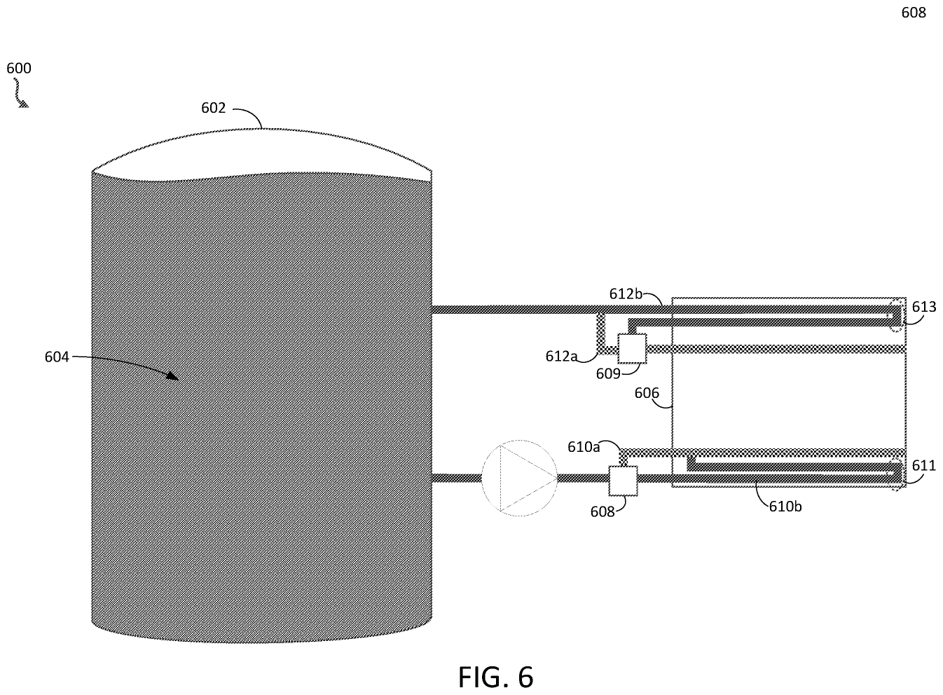

FIG. 6 provides a front view of a flow battery assembly 600 according to the present disclosure. As shown, assembly 600 can include a first reservoir 602 and one or more battery packs 606. First reservoir 602 can contain a first electrolyte solution 604. First electrolyte solution 604 can be either a liquid anolyte or a liquid catholyte. The one or more battery packs 606 can be electrically connected to each other in series. Each battery pack 606 can include a battery stack comprising at least one electrochemical cell and an enclosure enclosing the battery stack. A battery stack can include any number of electrochemical cells and can vary depending on the needs of the user. In the example shown in FIG. 6, assembly 600 includes one battery pack. This is exemplary only, and the number of battery packs is not fixed and can vary depending on the needs of the user. As an example, an assembly can include one, two, three, four, five, six, or more battery packs.

Each battery pack 606 can include a first supply flow path 610a. First supply flow path 610a can have a first length. First supply flow path 610a can be in fluid communication with first reservoir 602 and the corresponding battery stack. First supply flow path 610a can be configured to supply first electrolyte solution 604 to the corresponding battery stack. Battery pack 606 can also include a second supply flow path 610b. Second supply flow path 610b can have a second length. The second length can be greater than the first length. Second supply flow path 610b can be in fluid communication with first reservoir 602 and the battery stack of battery pack 606. Second supply flow path 610b can be configured to supply first electrolyte solution 604 to the battery stack of battery pack 606. Second supply flow path 410b can include at least a portion of first supply flow path 610a.

Battery pack 606 can include a first supply controller 608. First supply controller 608 can be configured to direct flow of first electrolyte solution 604 from first reservoir 602 to the battery stack of battery pack 606 between first supply flow path 610a and second supply flow path 610b based on certain conditions.

First supply controller 608 can be configured to direct flow of first electrolyte solution 604 from first reservoir 602 to the battery stack of battery pack 606 based at least on an operating power of assembly 600. If assembly 600 is operating at a high power (e.g., high nominal power), fluidic pressure drops can be a prominent source of inefficiency for assembly 600. Accordingly, if an operating power of assembly 600 meets or exceeds a power threshold, first supply controller 608 can be configured to direct flow of first electrolyte solution 604 from first reservoir 602 to the battery stack of battery pack 606 via the shorter of the two supply flow paths—first supply flow path 610a. Directing the flow of first electrolyte solution 604 from first reservoir 602 to the battery stack of battery pack 606 via the shorter of the two supply flow paths can mitigate fluidic pressure drops.

Conversely, if assembly 600 is operating at a low power (e.g., low nominal power), shunt currents, rather than fluidic pressure drops, can be a prominent source of inefficiency for assembly 600. Accordingly, if an operating power of assembly 600 is less than the power threshold, first supply controller 608 can be configured to direct flow of first electrolyte solution 604 from first reservoir 602 to the battery stack of battery pack 606 via the longer of the two supply flow paths—second supply flow path 610b. Directing the flow of first electrolyte solution 604 from first reservoir 602 to the battery stack of battery pack 606 via the longer of the two supply flow paths can mitigate shunt currents.

Additionally, or alternatively, first supply controller 608 can be configured to direct flow of first electrolyte solution 604 from first reservoir 602 to the battery stack of battery pack 606 based at least on a state of charge (SOC) of first electrolyte solution 604 flowing from first reservoir 602 to the battery stack. Shunt currents can be higher at higher SOCs. Accordingly, if a SOC of first electrolyte solution 404 meets or exceeds a SOC threshold (e.g., 80% SOC), first supply controller 608 can be configured to direct flow of first electrolyte solution 604 from first reservoir 602 to the battery stack of battery pack 606 via the longer of the two supply flow paths—second supply flow path 610b. Directing the flow of first electrolyte solution 604 from first reservoir 602 to the battery stack of battery pack 606 via the longer of the two supply flow paths can mitigate shunt currents.

If a SOC of first electrolyte solution 604 is high (e.g., meets or exceeds a SOC threshold) and assembly 600 is operating at a low power (e.g., at a power less than the power threshold), shunt currents can have the most detrimental impact on the efficiency of assembly 600. Thus, the benefit of directing the flow of first electrolyte solution 604 from first reservoir 602 to the battery stack of battery pack 606 via the longer of the two supply flow paths can be useful in such a scenario.

First supply flow path 610b can comprise a substantially U-shaped bend 611 such that a first portion of the first supply flow path 610b and a second portion of the first supply flow path 610b are positioned substantially parallel to each other and within the enclosure. In this manner, a length of first supply flow path 610b can be sufficiently extended to mitigate inter-stack shunt currents, while avoiding the downsides of external fluidic piping.

In the example shown in FIG. 6, each first supply flow path 610b comprises one substantially U-shaped bend such that a first portion of the first supply flow path 610b and a second portion of the first supply flow path 610b are positioned substantially parallel to each other and within the enclosure. This is exemplary only, and the number of substantially U-shaped bends is not fixed and can vary depending on the needs of the user. For example, any of the first supply flow paths 610b can further form an additional substantially U-shaped bend such that a third portion of the first supply flow path 610b and a fourth portion of the first supply flow path 610b are positioned substantially parallel to each other. The third portion and the fourth portion can be positioned substantially parallel to the first portion of the first supply flow path 610b and the second portion of the first supply flow path 610b and can be positioned within the enclosure.

In the example shown in FIG. 6, substantially U-shaped bends 611 is positioned internal to the enclosure. This is exemplary only, and the positioning of the substantially U-shaped bends is not fixed and can vary depending on the needs of the user. For example, one or more substantially U-shaped bends can be positioned external to the enclosure.

Each battery pack 606 can include a first return flow path 612a. First return flow path 612a can have a third length. Return flow path 612a can be in fluid communication with first reservoir 602 and the corresponding battery stack. First return flow path 612a can be configured to return first electrolyte solution 604 to first reservoir 602 after first electrolyte solution 604 has passed through the corresponding battery stack. Battery pack 606 can also include a second return flow path 612b. Second return flow path 612b can have a fourth length. The fourth length can be greater than the third length. Second return flow path 612b can be in fluid communication with first reservoir 602 and the battery stack of battery pack 606. Second return flow path 612b can be configured to return first electrolyte solution 604 to first reservoir 602 after first electrolyte solution 604 has passed through the battery stack. Second return flow path 612b can include at least a portion of first return flow path 612a.

Each battery pack 606 can include a first return controller 609. First return controller 609 can be configured to direct flow of first electrolyte solution 604 from the battery stack to first reservoir 602 between first return flow path 612a and second return flow path 612b based on certain conditions.

First return controller 609 can be configured to direct flow of first electrolyte solution 404 from the battery stack of battery pack 606 to first reservoir 602 based at least on an operating power of assembly 600. If assembly 600 is operating at a high power (e.g., high nominal power), fluidic pressure drops can be a prominent source of inefficiency for assembly 600. Accordingly, if an operating power of assembly 600 meets or exceeds a power threshold, first return controller 609 can be configured to direct flow of first electrolyte solution 604 from the battery stack of battery pack 606 to first reservoir 602 via the shorter of the two return flow paths—first return flow path 612a. Directing the flow of first electrolyte solution 604 from the battery stack of battery pack 606 to first reservoir 602 via the shorter of the two return flow paths can mitigate fluidic pressure drops.

Conversely, if assembly 600 is operating at a low power (e.g., low nominal power), shunt currents, rather than fluidic pressure drops, can be a prominent source of inefficiency for assembly 600. Accordingly, if an operating power of assembly 600 is less than the power threshold, first return controller 609 can be configured to direct flow of first electrolyte solution 606 from the battery stack of battery pack 606 to first reservoir 602 via the longer of the two return flow paths—second return flow path 612b. Directing the flow of first electrolyte solution 606 from the battery stack of battery pack 606 to first reservoir 602 via the longer of the two return flow paths can mitigate shunt currents.

Additionally, or alternatively, first return controller 609 can be configured to direct flow of first electrolyte solution 606 from the battery stack of battery pack 606 to first reservoir 602 based at least on a state of charge (SOC) of first electrolyte solution 606 flowing from the battery stack to first reservoir 602. Shunt currents can be higher at higher SOCs. Accordingly, if a SOC of first electrolyte solution 606 meets or exceeds a SOC threshold (e.g., 80% SOC), first return controller 609 can be configured to direct flow of first electrolyte solution 606 from the battery stack of battery pack 606 to first reservoir 602 via the longer of the two return flow paths—second return flow path 612b. Directing the flow of first electrolyte solution 606 from the battery stack of battery pack 606 to first reservoir 602 via the longer of the two return flow paths can mitigate shunt currents.

If a SOC of first electrolyte solution 606 is high (e.g., meets or exceeds a SOC threshold) and assembly 600 is operating at a low power (e.g., at a power less than the power threshold), shunt currents can have the most detrimental impact on the efficiency of assembly 600. Thus, the benefit of directing the flow of first electrolyte solution 606 from the battery stack of battery pack 606 to first reservoir 602 to via the longer of the two return flow paths can be particularly important in such a scenario.

First return flow path 612a can comprise a substantially U-shaped bend 613 such that a first portion of the first return flow path 612a and a second portion of the first return flow path 612a are positioned substantially parallel to each other and within the enclosure. In this manner, a length of first return flow path 612b can be sufficiently extended to mitigate inter-stack shunt currents, while avoiding the downsides of external fluidic piping.

In the example shown in FIG. 6, first return flow path 612b comprises one substantially U-shaped bend such that a first portion of first return flow path 612b and a second portion of first return flow path 612b are positioned substantially parallel to each other and within the enclosure. This is exemplary only, and the number of substantially U-shaped bends is not fixed and can vary depending on the needs of the user. For example, first return flow path 612b can further form an additional substantially U-shaped bend such that a third portion of first return flow path 612b and a fourth portion of first return flow path 612b are positioned substantially parallel to each other. The third portion and the fourth portion can be positioned substantially parallel to the first portion of first return flow path 612b and the second portion of first return flow path 612b c and can be positioned within the enclosure.

In the example shown in FIG. 6, substantially U-shaped bend 613 is positioned internal to the enclosure. This is exemplary only, and the positioning of the substantially U-shaped bends is not fixed and can vary depending on the needs of the user. For example, one or more substantially U-shaped bends can be positioned external to the enclosure.

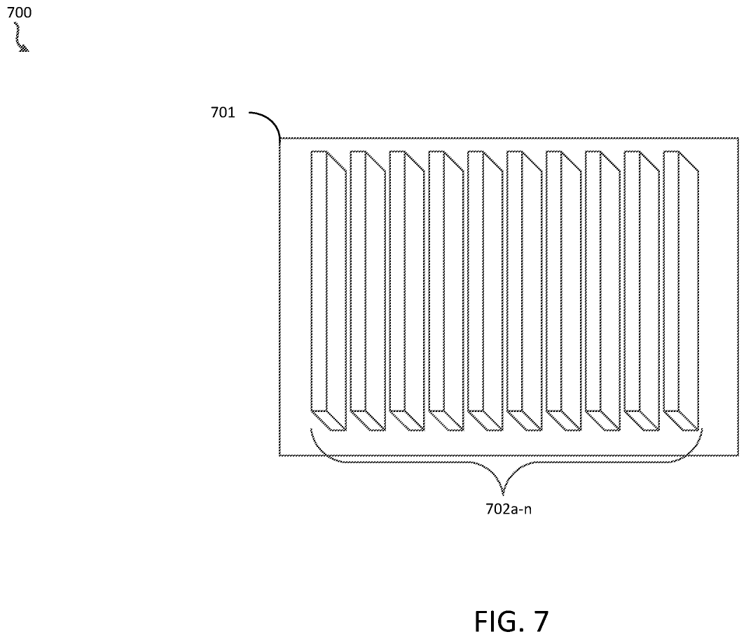

FIG. 7 provides a cross-sectional view of a battery pack 700 according to the present disclosure. As shown, battery pack 700 can include an enclosure 701 and one or one electrochemical cells 702a-n (collectively, a “battery stack”). Electrochemical cells 702a-n can be enclosed within enclosure 701. The number of electrochemical cells 702a-n can vary depending on the needs of the user. Battery pack 700 can be, for example, any of the battery packs described above with regard to FIGS. 1-6, including battery packs 106-c, battery pack, 406, and/or battery pack 606.

Aspects

The following Aspects are illustrative only and do not limit the scope of the present disclosure or the appended claims.

Aspect 1. A flow battery, comprising a first reservoir containing a first electrolyte solution; and one or more battery packs, a battery pack comprising: a battery stack comprising at least one electrochemical cell; an enclosure enclosing the battery stack; a first supply flow path configured to supply the first electrolyte solution to the battery stack, the first supply flow path being in fluid communication with the first reservoir and the battery stack, the first supply flow path comprising a substantially U-shaped bend such that a first portion of the first supply flow path and a second portion of the first supply flow path are positioned substantially parallel to each other and within the enclosure; and a first return flow path configured to return the first electrolyte solution to the first reservoir after the first electrolyte solution has passed through the battery stack, wherein the first return flow path is in fluid communication with the battery stack and the first reservoir, the first return flow path forming a substantially U-shaped bend such that a first portion of the first return flow path and a second portion of the first return flow path are positioned substantially parallel to each other and within the enclosure.

Aspect 2. The flow battery of Aspect 1, further comprising a second reservoir containing a second electrolyte solution, wherein the battery pack further comprises: a second supply flow path configured to supply the second electrolyte solution to the battery stack, wherein the second supply flow path is in fluid communication with the second reservoir and the battery stack, the second supply flow path forming a substantially U-shaped bend such that a first portion of the second supply flow path and a second portion of the second supply flow path are positioned substantially parallel to each other and within the enclosure; and a second return flow path configured to return the second electrolyte solution to the second reservoir after the second electrolyte solution has passed through the battery stack, wherein the second return flow path is in fluid communication with the battery stack and the second reservoir, the second return flow path forming a substantially U-shaped bend such that a first portion of the second return flow path and a second portion of the second return flow path are positioned substantially parallel to each other and within the enclosure.

Aspect 3. The flow battery of any one of Aspects 1-2, wherein the first supply flow path has a first length and the battery pack further comprises: a second supply flow path having a second length greater than the first length, the second supply flow path configured to supply the first electrolyte solution to the battery stack, wherein the second supply flow path is in fluid communication with the first reservoir and the at least one battery stack; and a controller configured to direct flow of the first electrolyte solution from the first reservoir to the battery stack between the first supply flow path and the second supply flow path based at least on an operating power of the flow battery.

Aspect 4. The flow battery of any one of Aspect 3, wherein the controller is configured to: cause the first electrolyte solution to flow from the first reservoir to the battery stack via the first supply flow path if an operating power of the flow battery meets or exceeds a threshold; and cause the first electrolyte solution to flow from the first reservoir to the battery stack via the second supply flow path if an operating power of the flow battery is less than the threshold.

Aspect 5. The flow battery of any one of Aspects 1-4, wherein the first return flow path has a first length and the battery pack further comprises: a second return flow path having a second length greater than the first length, the second return flow path configured to return the first electrolyte solution to the first reservoir after the first electrolyte solution has passed through the battery stack, wherein the second return flow path is in fluid communication with the first reservoir and the battery stack; and a controller configured to direct flow of the first electrolyte solution from the battery stack to the first reservoir between the first return flow path and the second return flow path based at least on a state of charge of the first electrolyte solution flowing from the battery stack to the first reservoir.

Aspect 6. The flow battery of any one of Aspects 1-5, wherein the first supply flow path further forms an additional substantially U-shaped bend such that a third portion of the first supply flow path and a fourth portion of the first supply flow path are positioned substantially parallel to each other, the third portion and the fourth portion positioned substantially parallel to the first portion of the first supply flow path and the second portion of the first supply flow path and within the enclosure; or the first return flow path further forms an additional substantially U-shaped bend such that a third portion of the first return flow path and a fourth portion of the first return flow path are positioned substantially parallel to each other, the third portion and the fourth portion positioned substantially parallel to the first portion of the first return flow path and the second portion of the first return flow path and within the enclosure.

Aspect 7. The flow battery of any one of Aspects 1-6, wherein at least one of the substantially U-shaped bend in the first supply flow path and the substantially U-shaped bend in the first return flow path is positioned external to the enclosure.

Aspect 8. The flow battery of any one of Aspects 1-7, wherein at least one of the substantially U-shaped bend in the first supply flow path and the substantially U-shaped bend in the first return flow path is positioned within the enclosure.

Aspect 9. The flow battery of any one of Aspects 1-8, wherein the one or more battery packs are electrically connected to each other in series.

Aspect 10. The flow battery of any one of Aspects 1-9, wherein the first electrolyte solution is a liquid anolyte or a liquid catholyte.

Aspect 11. A flow battery, comprising a first reservoir containing a first electrolyte solution; at least one battery stack; a first supply flow path having a first length, the first supply flow path configured to supply the first electrolyte solution to the at least one battery stack, wherein the first supply flow path is in fluid communication with the first reservoir and the at least one battery stack; a second supply flow path having a second length greater than the first length, the second supply flow path configured to supply the first electrolyte solution to the at least one battery stack, wherein the second supply flow path is in fluid communication with the first reservoir and the at least one battery stack; and a first controller configured to direct flow of the first electrolyte solution from the first reservoir to the at least one battery stack between the first supply flow path and the second supply flow path based at least on an operating power of the flow battery.

Aspect 12. The flow battery of Aspect 11, wherein the first controller is configured to: cause the first electrolyte solution to flow from the first reservoir to the at least one battery stack via the first supply flow path if the operating power of the flow battery meets or exceeds a threshold; and cause the first electrolyte solution to flow from the first reservoir to the at least one battery stack via the second supply flow path if the operating power of the flow battery is less than the threshold.

Aspect 13. The flow battery of any one of Aspects 11-12, wherein the at least one battery stack is contained within an enclosure, and wherein the second supply flow path forms a substantially U-shaped bend such that a first portion of the second supply flow path and a second portion of the second supply flow path are positioned substantially parallel to each other and within the enclosure.

Aspect 14. The flow battery of any one of Aspects 11-13, further comprising a first return flow path having a third length, the first return flow path configured to return the first electrolyte solution to the first reservoir after the first electrolyte solution has passed through the at least one battery stack, wherein the first return flow path is in fluid communication with the at least one battery stack and the first reservoir; a second return flow path having a fourth length greater than the third length, the second return flow path configured to return the first electrolyte solution to the first reservoir after the first electrolyte solution has passed through the at least one battery stack, wherein the second return flow path is in fluid communication with the first reservoir and the at least one battery stack; and a second controller configured to alternate flow of the first electrolyte solution from the at least one battery stack to the first reservoir between the first return flow path and the second return flow path based at least on an operating power of the flow battery.

Aspect 15. The flow battery of Aspect 14, wherein the second controller is configured to: cause the first electrolyte solution to flow from the at least one battery stack to the first reservoir via the third supply flow path if the operating power of the flow battery meets or exceeds a threshold; and cause the first electrolyte solution to flow from the at least one battery stack to the first reservoir via the second supply flow path if the operating power of the flow battery is less than the threshold.

Aspect 16. The flow battery of Aspect 14, wherein the at least one battery stack is contained within an enclosure, and wherein the second return flow path forms a substantially U-shaped bend such that a first portion of the second return flow path and a second portion of the second return flow path are positioned substantially parallel to each other and within the enclosure.

Aspect 17. The flow battery of any one of Aspects 11-16, a second reservoir containing a second electrolyte solution; and a third supply flow path having a third length, the third supply flow path configured to supply the second electrolyte solution to the at least one battery stack, wherein the third supply flow path is in fluid communication with the at least one battery stack; a fourth supply flow path having a fourth length greater than the third length, the fourth supply flow path configured to supply the second electrolyte solution to the at least one battery stack, wherein the fourth supply flow path is in fluid communication with the second reservoir and the at least one battery stack; and a second controller configured to alternate flow of the second electrolyte solution from the second reservoir to the at least one battery stack between the third supply flow path and the fourth supply flow path based at least on an operating power of the flow battery.

Aspect 18. The flow battery of Aspect 17, wherein the second controller is configured to: cause the second electrolyte solution to flow from the second reservoir to the at least one battery stack via the third supply flow path if the operating power of the flow battery meets or exceeds a threshold; and cause the second electrolyte solution to flow from the second reservoir to the at least one battery stack via the fourth supply flow path if the operating power of the flow battery is less than the threshold.

Aspect 19. The flow battery of Aspect 17, further comprising a first return flow path having a fifth length, the first return flow path configured to return the second electrolyte solution to the second reservoir after the second electrolyte solution has passed through the at least one battery stack, wherein a the first return flow path is in fluid communication with the at least one battery stack and the second reservoir; a second return flow path having a sixth length greater than the fifth length, the second return flow path configured to return the second electrolyte solution to the second reservoir after the second electrolyte solution has passed through the at least one battery stack, wherein a first end of the second return flow path is connected to the second reservoir and a second end of the second return flow path is connected to the at least one battery stack; and a third controller configured to alternate flow of the second electrolyte solution from the at least one battery stack to the second reservoir between the first return flow path and the second return flow path based at least on an operating power of the flow battery.

Aspect 20. The flow battery of Aspect 11, wherein the first electrolyte solution is a liquid anolyte or a liquid catholyte.

Aspect 21. A method, comprising operating a flow battery according to any one of Aspects 1-20.

Aspect 22. A method, comprising collecting a current from a flow battery according to any one of Aspects 1-20.

Aspect 23. A method, comprising providing a current to a flow battery according to any one of Aspects 1-20.

What is claimed:

1. A flow battery, comprising:
a first reservoir containing a first electrolyte solution; and
one or more battery packs, a battery pack comprising:
a battery stack comprising at least one electrochemical cell;
an enclosure enclosing the battery stack;
a first supply flow path configured to supply the first electrolyte solution to the battery stack, the first supply flow path being in fluid communication with the first reservoir and the battery stack, the first supply flow path comprising a substantially U-shaped bend such that a first portion of the first supply flow path and a second portion of the first supply flow path are positioned substantially parallel to each other and within the enclosure; and
a first return flow path configured to return the first electrolyte solution to the first reservoir after the first electrolyte solution has passed through the battery stack, wherein the first return flow path is in fluid communication with the battery stack and the first reservoir, the first return flow path forming a substantially U-shaped bend such that a first portion of the first return flow path and a second portion of the first return flow path are positioned substantially parallel to each other and within the enclosure.

2. The flow battery of claim 1, further comprising:
a second reservoir containing a second electrolyte solution, wherein the battery pack further comprises:
a second supply flow path configured to supply the second electrolyte solution to the battery stack, wherein the second supply flow path is in fluid communication with the second reservoir and the battery stack, the second supply flow path forming a substantially U-shaped bend such that a first portion of the second supply flow path and a second portion of the second supply flow path are positioned substantially parallel to each other and within the enclosure; and
a second return flow path configured to return the second electrolyte solution to the second reservoir after the second electrolyte solution has passed through the battery stack, wherein the second return flow path is in fluid communication with the battery stack and the second reservoir, the second return flow path forming a substantially U-shaped bend such that a first portion of the second return flow path and a second portion of the second return flow path are positioned substantially parallel to each other and within the enclosure.

3. The flow battery of claim 1, wherein the first supply flow path has a first length and the battery pack further comprises:
a second supply flow path having a second length greater than the first length, the second supply flow path configured to supply the first electrolyte solution to the battery stack, wherein the second supply flow path is in fluid communication with the first reservoir and the at least one battery stack; and
a controller configured to direct flow of the first electrolyte solution from the first reservoir to the battery stack between the first supply flow path and the second supply flow path based at least on an operating power of the flow battery.

4. The flow battery of claim 3, wherein the controller is configured to:
cause the first electrolyte solution to flow from the first reservoir to the battery stack via the first supply flow path if the operating power of the flow battery meets or exceeds a threshold; and
cause the first electrolyte solution to flow from the first reservoir to the battery stack via the second supply flow path if the operating power of the flow battery is less than the threshold.

5. The flow battery of claim 1, wherein the first return flow path has a first length and the battery pack further comprises:
a second return flow path having a second length greater than the first length, the second return flow path configured to return the first electrolyte solution to the first reservoir after the first electrolyte solution has passed through the battery stack, wherein the second return flow path is in fluid communication with the first reservoir and the battery stack; and
a controller configured to direct flow of the first electrolyte solution from the battery stack to the first reservoir between the first return flow path and the second return flow path based at least on an operating power of the flow battery.

6. The flow battery of claim 1, wherein the first supply flow path further forms an additional substantially U-shaped bend such that a third portion of the first supply flow path and a fourth portion of the first supply flow path are positioned substantially parallel to each other, the third portion and the fourth portion positioned substantially parallel to the first portion of the first supply flow path and the second portion of the first supply flow path and within the enclosure; or
the first return flow path further forms an additional substantially U-shaped bend such that a third portion of the first return flow path and a fourth portion of the first return flow path are positioned substantially parallel to each other, the third portion and the fourth portion positioned substantially parallel to the first portion of the first return flow path and the second portion of the first return flow path and within the enclosure.

7. The flow battery of claim 1, wherein at least one of the substantially U-shaped bend in the first supply flow path and the substantially U-shaped bend in the first return flow path is positioned external to the enclosure.

8. The flow battery of claim 1, wherein at least one of the substantially U-shaped bend in the first supply flow path and the substantially U-shaped bend in the first return flow path is positioned within the enclosure.

9. The flow battery of claim 1, wherein the one or more battery packs are electrically connected to each other in series.

10. The flow battery of claim 1, wherein the first electrolyte solution is a liquid anolyte or a liquid catholyte.

11. A flow battery, comprising:
a first reservoir containing a first electrolyte solution;
at least one battery stack;
a first supply flow path having a first length, the first supply flow path configured to supply the first electrolyte solution to the at least one battery stack, wherein the first supply flow path is in fluid communication with the first reservoir and the at least one battery stack;
a second supply flow path having a second length greater than the first length, the second supply flow path configured to supply the first electrolyte solution to the at least one battery stack, wherein the second supply flow path is in fluid communication with the first reservoir and the at least one battery stack; and
a first controller configured to direct flow of the first electrolyte solution from the first reservoir to the at least one battery stack between the first supply flow path and the second supply flow path based at least on an operating power of the flow battery.

12. The flow battery of claim 11, wherein the first controller is configured to:
cause the first electrolyte solution to flow from the first reservoir to the at least one battery stack via the first supply flow path if the operating power of the flow battery meets or exceeds a threshold; and
cause the first electrolyte solution to flow from the first reservoir to the at least one battery stack via the second supply flow path if the operating power of the flow battery is less than the threshold.

13. The flow battery of claim 11, wherein the at least one battery stack is contained within an enclosure, and wherein the second supply flow path forms a substantially U-shaped bend such that a first portion of the second supply flow path and a second portion of the second supply flow path are positioned substantially parallel to each other and within the enclosure.

14. The flow battery of claim 11, further comprising:
a first return flow path having a third length, the first return flow path configured to return the first electrolyte solution to the first reservoir after the first electrolyte solution has passed through the at least one battery stack, wherein the first return flow path is in fluid communication with the at least one battery stack and the first reservoir;
a second return flow path having a fourth length greater than the third length, the second return flow path configured to return the first electrolyte solution to the first reservoir after the first electrolyte solution has passed through the at least one battery stack, wherein the second return flow path is in fluid communication with the first reservoir and the at least one battery stack; and
a second controller configured to alternate flow of the first electrolyte solution from the at least one battery stack to the first reservoir between the first return flow path and the second return flow path based at least on an operating power of the flow battery.

15. The flow battery of claim 14, wherein the second controller is configured to:
cause the first electrolyte solution to flow from the at least one battery stack to the first reservoir via the third supply flow path if the operating power of the flow battery meets or exceeds a threshold; and
cause the first electrolyte solution to flow from the at least one battery stack to the first reservoir via the second supply flow path if the operating power of the flow battery is less than the threshold.

16. The flow battery of claim 14, wherein the at least one battery stack is contained within an enclosure, and wherein the second return flow path forms a substantially U-shaped bend such that a first portion of the second return flow path and a second portion of the second return flow path are positioned substantially parallel to each other and within the enclosure.

17. The flow battery of claim 11, further comprising:
a second reservoir containing a second electrolyte solution; and
a third supply flow path having a third length, the third supply flow path configured to supply the second electrolyte solution to the at least one battery stack, wherein the third supply flow path is in fluid communication with the at least one battery stack;
a fourth supply flow path having a fourth length greater than the third length, the fourth supply flow path configured to supply the second electrolyte solution to the at least one battery stack, wherein the fourth supply flow path is in fluid communication with the second reservoir and the at least one battery stack; and
a second controller configured to alternate flow of the second electrolyte solution from the second reservoir to the at least one battery stack between the third supply flow path and the fourth supply flow path based at least on an operating power of the flow battery.

18. The flow battery of claim 17, wherein the second controller is configured to:
cause the second electrolyte solution to flow from the second reservoir to the at least one battery stack via the third supply flow path if the operating power of the flow battery meets or exceeds a threshold; and
cause the second electrolyte solution to flow from the second reservoir to the at least one battery stack via the fourth supply flow path if the operating power of the flow battery is less than the threshold.

19. The flow battery of claim 17, further comprising:
a first return flow path having a fifth length, the first return flow path configured to return the second electrolyte solution to the second reservoir after the second electrolyte solution has passed through the at least one battery stack, wherein a the first return flow path is in fluid communication with the at least one battery stack and the second reservoir;
a second return flow path having a sixth length greater than the fifth length, the second return flow path configured to return the second electrolyte solution to the second reservoir after the second electrolyte solution has passed through the at least one battery stack, wherein a first end of the second return flow path is connected to the second reservoir and a second end of the second return flow path is connected to the at least one battery stack; and
a third controller configured to alternate flow of the second electrolyte solution from the at least one battery stack to the second reservoir between the first return flow path and the second return flow path based at least on an operating power of the flow battery.

20. The flow battery of claim 11, wherein the first electrolyte solution is a liquid anolyte or a liquid catholyte.
